(19) United States
(12) Patent Application Publication
(10) Pub. No.: US 2006/0103048 A1
(43) Pub. Date: May 18, 2006

(54) Extrusion die for making a part with controlled geometry

(76) Inventor: Aaron T. Crumm, Ann Arbor, MI (US)

Correspondence Address: Miller, Canfield, Paddock and Stone P.L.C.;c/o Robert Kelley Roth, 150 West Jefferson Ave, Suite 2500, Detroit, MI, 48226, US

(21) Appl. No.: 10/991,295

(22) Filed: Nov. 17, 2004

(51) Int. Cl. B29C 47/20

(52) U.S. Cl. 264/211.21; 425/380

(57) ABSTRACT

An extrusion die for extruding a material and method of making a part using an extrusion die is disclosed comprising a cylinder, a cone mounted on the cylinder, an extrusion assembly having a core and a cylindrical tip. The extrusion assembly is positioned within the cylinder and cooperates with the cone and the cylinder to define a cavity. The cavity ends at an exit at the tip and the exit comprises an exterior defined by the reduction cone and an interior defined by the tip. A ram is positioned around the core and is movable from a retracted position to an extended position.

### FIELD OF THE INVENTION

This invention relates to an extrusion die for making a part with controlled geometry, and more particularly, to an apparatus for making hollow parts extruded with a plurality of layers.

### BACKGROUND OF THE INVENTION

It is desirable in some applications to make hollow parts. In some instances, it is desirable to make hollow parts in the form of tubes having more than one layer where the layers are precisely arranged with respect to one another. Conventional methods of extruding a tube force a resin material or extrudate through a die with a fixed core which determines its inner diameter. The core is held within the die cavity by connecting support elements or beams. These are commonly called “spider dies” since the beams are like the legs of a spider. Conventional spider dies separate the flow of the extrudate into separate streams, which are re-connected in the orifice of the die. Spider dies cannot be used to produce multilayer tubes from a single source of extrudate, because of the stream of extrudate is separated at the beams.

Another technique for making a hollowed part with multiple layers used a controlled geometry feedrod having a fugitive material in the center which could be removed by heating, leaving a part with a hollow interior. The controlled geometry feedrods cannot be used with a spider die. Further, the fugitive material is wasted in the process. It would be desirable to provide an extrusion die which allowed for manufacture of parts with multiple layers with controlled geometry.

### SUMMARY OF THE INVENTION

An extrusion die for extruding a material and method of making a part using an extrusion die is disclosed comprising a cylinder, a cone mounted on the cylinder, an extrusion assembly having a core and a cylindrical tip. The extrusion assembly is positioned within the cylinder and cooperates with the cone and the cylinder to define a cavity. The cavity ends at an exit at the tip and the exit comprises an exterior defined by the reduction cone and an interior defined by the tip. A ram is positioned around the core and movable from a retracted position to an extended position. The part made may have multiple layers with a controlled geometry.

### BRIEF DESCRIPTION OF THE DRAWINGS

FIG. 1 is a cross section view of an extrusion die in accordance with a preferred embodiment.

FIG. 2 is an example of a preferred embodiment of an extrusion assembly for use in the extrusion die of FIG. 1.

FIG. 3 shows an example of an annular feedrod having multiple layers, and the tube produced from the feedrod.

It should be understood that the appended drawings are not necessarily to scale, presenting a somewhat simplified representation of various preferred features illustrative of the basic principles of the invention. The specific design features of the molding equipment as disclosed here, including, for example, specific dimensions of the extrusion die will be determined in part by the particular intended application and use environment. Certain features of the illustrated embodiments have been enlarged or distorted relative to others to help visualization and clear understanding. In particular, thin features may be thickened, for example, for clarity of illustration. All references to direction and position, unless otherwise indicated, refer to the orientation of the extrusion die illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the extrusion die disclosed herein. The following detailed discussion of various alternative and preferred features and embodiments will illustrate the general principles of the invention with reference to an extrusion die suitable for manufacture of tubes having multiple layers. Other embodiments suitable for other applications will be apparent to those skilled in the art given the benefit of this disclosure.

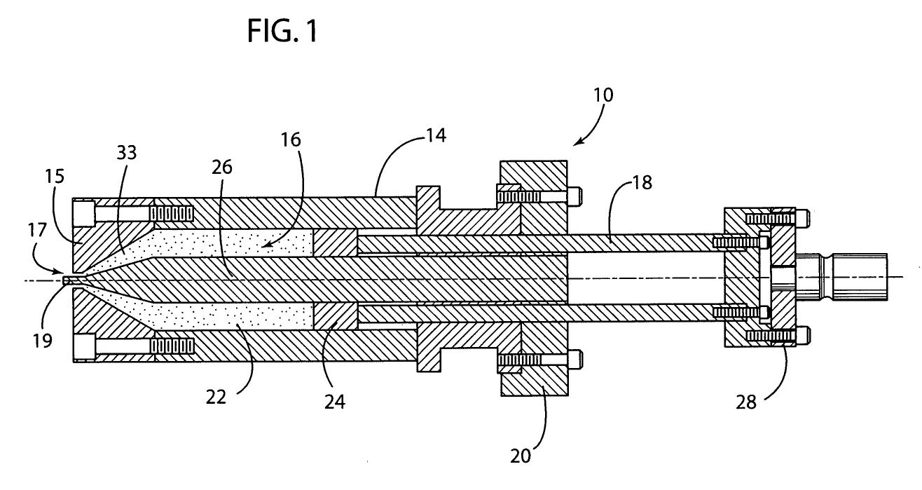

Turning now to the drawings, FIG. 1 shows a cross section view of an extrusion die 10 in accordance with a preferred embodiment. The extrusion die shown reduces the size of a feedrod while maintaining a controlled geometry. Controlled geometry is understood here to mean that the relationship between various layers of the feedrod stay the same in the final extruded part.

A cylinder 14 has a cone 15 mounted on one end. The cone 15 has an opening which at least partially defines an exit 17. The exit 17 leads to a cavity 16 which receives a feedrod 22. As shown in the drawings, the exit is has a tubular cross section and a cylindrical tip 19 extends into the exit. The cone 15 defines an exterior (in FIG. 1, an external diameter) and the tip defines an interior (an internal diameter) of the exit. The interior and exterior correspond to the shape of the part extruded. Other cross sections for the exit may be used, such as a square cross section, for example.

The cone 15 cooperates with a narrowing of a central core 26 to define a cone reduction region 33 leading to the exit 17. The feedrod 22 is shown positioned in the cavity 16 between the exit 17 and a ram 24. Ram 24 is positioned around the core 26 and is movable through the cavity 16 from a retracted position where the ram is remote from the cone 15 to an extended position where the ram moves closer to the cone 15. One or more pushrods 18 are positioned behind the ram 24, and push and pull the ram between the extended and retracted positions. Preferably the ram is slidable over the outside of the core 26.

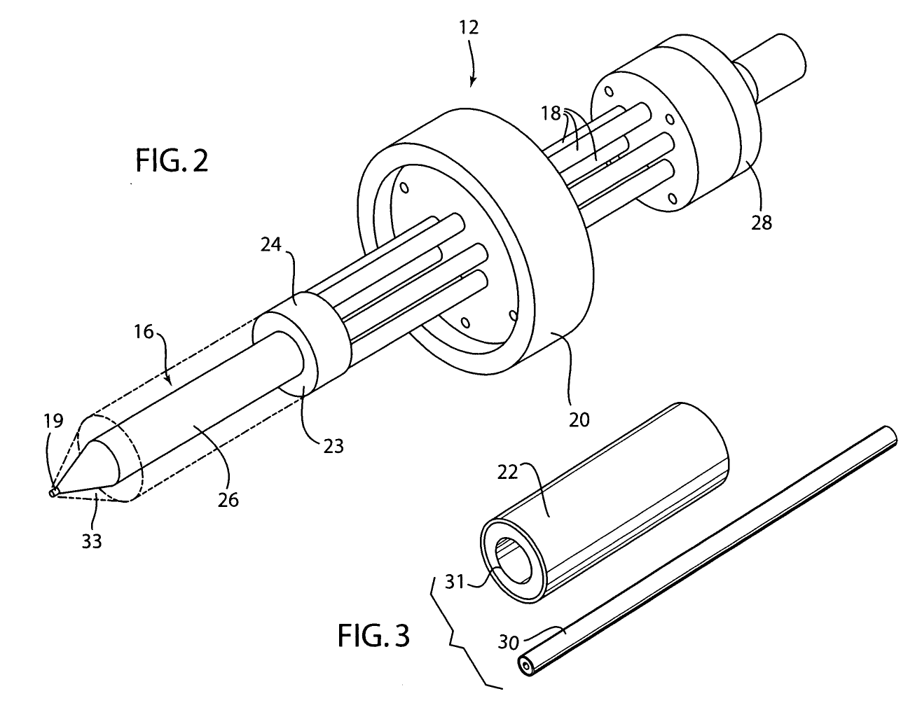

The cylindrical tip 19 is the end of the central core 26. Preferably the core 26 is mounted on the cylinder and cooperates with the cylinder 14 to define the opening 16 which receives the feedrod. FIG. 2 is a perspective view showing an extrusion assembly or “thumbtack” 12 which comprises the fixed central core 26 and the tip 19. The ram 24, shown here as an annular ram, has a back wall 23 which cooperates to define the cavity. The feedrod 22 contacts the back wall of the ram and is forced through the exit to make a part 30, shown in FIG. 3 as a coextruded tube. Advantageously when the feedrod 22 has multiple layers, those multiple layers are maintained without disruption in the final part.

An endcap 20 may be rigidly mounted on the cylinder 14, and the core 26 mounted on the end cap. This holds the core in place as the ram slides over it. Preferably push rods 18 slide through openings in the endcap 20 in response to a drive motor (not shown) connected at a coupler 28.

A preferred method of making the part 30 comprises forming a multilayer feedrod 22 from a thermoplastic compound. This involves bonding onto a thermoplastic rod of a first layer one or more layers of additional materials, each prepared such that their flow behavior under extrusion conditions are matched close enough to enable a change in shape without distortion of the design. The feedrod 22 is fashioned here as a hollow cylinder which has a central opening 31 which fits over the central core 26. One way of doing this is to form the feedrod as a solid cylinder and then remove the central material by drilling to form the central opening 31. As the drilled material is not subject to a chemical change, it may optionally be recycled and used again. The feedrod is forced through the reduction section of the extrusion die using the thumbtack 12, without flow separations. Other techniques for forming a hollow feedrod will be readily apparent to those skilled in the art given the benefit of this disclosure.

Advantageously, the controlled geometry feedrod can produce a tube from a first layer and a second layer (and more layers, if desired) by simultaneous coextrusion. Insertion of the feedrod into the cavity may be accomplished by, for example, removal of screws holding the cone 15 in place, with insertion over the central core 26. The ram 24 forces the feedrod through the cavity 16 to the reduction region 33 and out the exit to form the part 30. Secondary operations can be performed on the part 30 such as cutting to a desired length and heating. The part 30 so formed has a first layer corresponding to the first layer of the feedrod, and a second layer corresponding to the second layer of the feedrod.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. An extrusion die for extruding a material comprising, in combination:
a cylinder;
a cone mounted on the cylinder;
an extrusion assembly having a core and a cylindrical tip; the thumbtack being positioned within the cylinder and cooperating with the cone and the cylinder to define a cavity;
wherein the cavity ends at an exit at the tip, and the exit comprising an exterior defined by the cone and an interior defined by the tip; and
a ram positioned around the core and movable through the cavity from a retracted position toward the exit to an extended position.

2. The extrusion die of claim 1 wherein the ram is remote from the cone in the retracted position and closer to the cone in the extended position.

3. The extrusion die of claim 1 further comprising a feedrod positioned in the cavity between the ram and the exit, wherein the feedrod is extruded through the exit in response to movement of the ram from the retracted position to the extended position.

4. The extrusion die of claim 3 wherein the feedrod comprises more than one layer of material.

5. The extrusion die of claim 1 wherein the cavity has an outside diameter which narrows at the exit to the exterior.

6. The extrusion die of claim 1 further comprising pushrods mounted behind the ram which push and pull the ram between the extended and retracted positions.

7. The extrusion die of claim 6 further comprising an endcap held rigid with the cylinder, wherein the pushrods slide within the endcap as the ram moves between the extended and retracted positions.

8. The extrusion die of claim 1 further comprising an endcap held rigid to the cylinder, wherein the core is attached to the endcap.

9. A method of making a part comprising in combination, the steps of:
forming a feedrod having a central opening and comprising a first layer and a second layer;
placing the feedrod into an extrusion die having a cylinder, a fixed central core and a movable ram mounted inside the cylinder, wherein the central opening is sized to receive the central core; and
extruding the part by using the ram to force the feedrod through an exit.

10. The method of claim 9 further comprising a cone mounted to the cylinder at the exit wherein the cone partially defines the shape of the exit.

11. The method of claim 10 wherein the cone cooperates with the cylinder to form a tubular cross section at the exit comprising an external diameter defined by the cone and an internal diameter defined by the cylinder.

12. The method of claim 11 wherein the extrusion die is a reduction die and the cylinder narrows to a tip.

13. The method of claim 9 wherein the part has a first layer corresponding to the first layer of the feedrod, and a second layer corresponding to the second layer of the feedrod.

14. The method of claim 9 wherein the step of forming the feedrod further comprises forming the feedrod as a solid cylinder and removing a portion of the first layer to form the central opening.
